(19) United States
(12) Patent Application Publication
(10) Pub. No.: US 2023/0018381 A1
(43) Pub. Date: Jan. 19, 2023

(54) METHOD FOR AUTOMATICALLY IDENTIFYING DESIGN CHANGES IN BUILDING INFORMATION MODEL

(71) Applicant: Tsinghua University, Beijing (CN)

(72) Inventors: Jiarui LIN, Beijing (CN); Yucheng ZHOU, Beijing (CN)

(21) Appl. No.: 17/782,886

(22) PCT Filed: Feb. 26, 2020
(86) PCT No.: PCT/CN2020/076700

§ 371 Date: Jun. 6, 2022

(30) Foreign Application Priority Data
Dec. 11, 2019 (CN) 201911265693.6

(51) Int. Cl. G06Q 50/08; G06F 30/13; G06F 16/583

(52) U.S. Cl. CPC G06Q 50/08; G06F 30/13; G06F 16/5854

(57) ABSTRACT

A method for automatically identifying design changes in a building information model includes steps of: S1, encoding all objects in an old file and a new file, and taking out an object from the old or new file; S2, determining whether code of the object can be equal to code of one or more objects in the new or old file, if so, then the object is not changed, if not, proceeding to the next step; S3, determining whether the object can match an object in the new or old file, if so, the object is a modified object, if not, the object is a deleted or newly added object; and S4, outputting an identification outcome and returning to the step S1 until identification to be applied on all objects in the old or new files is completed.

### RELATED APPLICATIONS

The present application is a U.S. National Phase of International Application Number PCT/CN2020/076700 filed Feb. 26, 2020, and claims priority to Chinese Application Number 201911265693.6, filed Dec. 11, 2019.

### FIELD OF THE INVENTION

The present disclosure relates to a method for automatically identifying design changes in a building information model, and belongs to the technical field of building information technology.

### BACKGROUND OF THE INVENTION

Building Information Model (BIM) is an integrated means widely used for establishment of full life cycle management of buildings. BIM software for various specialties have been widely utilized in construction a project, so that the importance of identifying design changes in BIM has become increasingly prominent. For example, due to existence of multi-discipline collaborative design, designers need to share and exchange data among different software, in which case identification of design changes can reduce transmitted information by using partial model exchange, and thus improves work efficiency. In addition, identification of design changes in a BIM also helps designers, engineers, and managers rapidly spot and focus on changes in the design process without having to review the entire model each time. However, manual checking for design changes is time-consuming and error-prone, so research into automatic identification of design changes has great significance.

At present, many methods for design change identification are based on object identifier (ID) matching, and execute identification by comparing all attributes of every instance in a BIM model. However, such design change outcome resulted from data changes doesn't always make sense to the designers. For example, a design change, such as swapping positions of two columns having the same attributes or deleting a beam then recreating the same one, alters no structure of the building at all, and thus should not be considered as a design change. In addition, many existing methods for design change identification are sensitive to IDs so that no correct outcome would be resulted once an ID was changed unexpectedly. In view of the above-mentioned disadvantages of those methods for design change identification, improved identification methods, such as a comparison method based on component geometry and an automatic comparison method based on element content, have been proposed in the prior art. However, these improved identification methods still cannot completely eliminate an identification outcome having no project significance, and further cost a large amount of computation and time.

Classification of design changes usually involves two files, which are defined as a new file and an old file. The current common classification of design changes is to divide elements in these files into the following three categories:
NEW: elements only exist in the new file.
DELETE: element exists only in the old file.
MODIFY: element exists in both the old and new files, but some attributes have been changed.

Algorithms for design change identification each include the following two steps:
Matching: determining whether an element exists in the new file, the old file, or both the new and old files. This step uses IDs to match elements between the two files. A successfully matched element refers to the one existing in both the old and new files, and an unmatched element refers to the one existing in only one of the files.
Comparison: determining whether attributes of two elements are equal. All attributes except ID of the element are used for the comparison.

According to the above two steps, the algorithms for design change identification are divided into the following two classes:
Matching priority algorithm: the step of matching is performed first, and then the step of comparison.
Comparison priority algorithm: the step of comparison is performed first, and then the step of matching.

The matching priority algorithm has the following problems:

1. Dependence on IDs. Since this algorithm performs the step of matching first, i.e. firstly comparing IDs of the elements between the two files, an incorrect outcome would be resulted if the IDs are unreliable.

2. Identifying meaningless changes as an outcome of design changes.

In order to address the problems of the matching priority algorithm, the comparison priority algorithm has been developed. Since the step of comparison requires reading all attributes of an element, the dependence on IDs can be avoided. Further, its correctness and project significance have been greatly improved than that of the matching priority algorithm. However, the comparison priority algorithm still has the following shortcomings:

1. High time cost: the step of comparison requires reading all attributes of an element, due to such manner of which the number of executions of the step of comparison will be greatly increased, thus greatly increasing the time cost. In a practical test, it is found that the time cost of the comparison priority algorithm would be more than 50 times that of the matching priority algorithm when the model is of large scale (e.g. containing tens of thousands of elements).

2. Although, compared with the matching priority algorithm, the correctness and the project significance has been greatly improved in the comparison priority algorithm, a small amount of meaningless outcomes are still produced in practice. This is because the existing step of comparison is to compare all attributes of the element one by one, but some attributes of the element, similar to the IDs, are also meaningless to the designers (such as element owner history, creation time, etc.), so these meaningless attributes should be ignored in the step of comparison.

### SUMMARY OF THE INVENTION

In view of the above problems, an objective of the present disclosure is to provide a method for automatically identifying design changes in a building information model (BIM), which detects changes at type level and at model level so as to ensure accuracy and project significance of BIM outcomes without identifying any outcome of meaningless.

The present disclosure discloses a method for automatically identifying design changes in a BIM model, comprising steps of: S1, taking out an object from an old file or a new file; S2, extracting data objects of all data change categories in the object; S3, checking for change at object level, and determining whether a data object of each category can be equal to any object in the new or old file, if so, then the object is not changed, if not, proceeding to the next step; S4, determining whether an ID of the object in the step Si matches an ID of any object in the new file or the old file, if so, the object is the one that has been modified, if not, the object is the one that has been deleted or newly added; S5, checking whether change at type level occurs; S6, upon completion of checking for the changes at object level and at type level, checking whether the changes are meaningless in the perspective of model level; and S7, outputting an identification outcome and then going back to the step Si until identification to be applied on all objects in the old or new files is completed.

Further, in the step S2, the data change categories of the object includes a category of attribute data, a category of shape data, and a category of relationship data.

Further, data changes in the category of attribute data include: newly adding, deleting, and modifying attribute data; data changes in the category of shape data include: newly adding, deleting, and modifying geometry; data changes in the category of relationship data include: newly adding, deleting and modifying relational object, and modifying object's connection relationship.

Further, the type level in the step S5 is to: figure out modifying attribute value, modifying attribute name, and modifying order of attributes in modification of the category of attribute data; figure out modifying geometry, modifying position, and modifying expression in modification of the category of shape data; figure out modifying relational object and modifying object's connection relationship in modification of the category of relationship data; and classify, from all objects, the objects that have undergone the same data change into one same class.

Based on one same inventive concept, the present disclosure further discloses a method for automatically identifying design changes in a IBM model, which comprise steps of: S1, encoding all objects in both the old and new files, and taking out an object from the old or new file; S2, determining whether code of the object can be equal to code of one or more objects in the new or old file, if so, then the object is not changed, if not, proceeding to the next step; S3, determining whether the object can match an object in the new or old file, if so, the object is a modified one, if not, the object is a deleted or newly added one; and S4, outputting an identification outcome and returning to the step Si until identification to be applied on all objects in the old or new files is completed.

Further, a method for determining the code specifically comprises: S1.1, taking out an object from the old or new file; S1.2, extracting data of all categories of data changes of the object; S1.3, computing a piece of code for each category of the object according to the data of all categories of data changes of the object; and S1.4, integrating all pieces of code into one piece, and using it as object code.

Further, in the step S1.2, the categories of data changes of the object include: a category of attribute data, a category of shape data, and a category of relationship data.

Further, data changes in the category of attribute data include: adding, deleting and modifying attribute value, modifying attribute name, and modifying order of attributes; data changes in the category of shape data include: adding, deleting and modifying geometry, modifying position, and modifying expression; and data changes in the category of relationship data include: adding, deleting and modifying relational object, and modifying object's connection relationship.

Further, in order for integrating all pieces of code into one piece in the step S1.4, it is required to check for the change at object level, the change at type level and the change at model level in turn, and to check whether the changes are meaningless in the perspective of the model level.

Further, a step of proofreading is included to avoid an encoding conflict; the step of proofreading specifically comprises that: in the step S2, it is determined whether the code of said object can be equal to code of one or more objects in the new or old file, if so, then it is determined whether said object is completely the same as an object among those objects having equal code with it, if so, then said object is not changed, otherwise, it is determined that there is an encoding conflict, and proceeded to the step S3.

The present disclosure has the following advantages by adopting the above-mentioned technical solutions:

1. By detecting the change type level and the change at model level, the first method for automatic identification provided herein ensures accuracy and project significance of BIM outcomes without identifying any outcome of meaningless. So far, a comparison priority algorithm has been the best way to identify changes in an accurate and project-significant manner, but it still fails to guarantee that the outcomes all have their project significance entirely because a classification standard of design changes in use considers no semantic meaning of the objects in the model. Therefore, upon a new classification standard of design changes that takes the project significance into account is proposed, the comparison priority algorithm can achieve the purpose of ensuring accuracy and project significance by using this standard.

2. In the second method for automatic identification, by providing code correlated to the data change categories and the design change levels, the method computes firstly pieces of code for all objects and uses them as a condition for determining whether objects are equal so that a volume of objects' attributes to be read can be significantly reduced in a subsequent step of comparison. In this way, not only the problem of identifying meaningless outcomes can be addressed, but also the processing speed of the method for automatic identification can be greatly improved. The encoding-based method for rapidly and automatically identifying changes can save up to 98.1% of the time compared with the comparison priority algorithm.

3. During a multi-discipline collaborative design, through helping identify changes in model files in a rapid and accurate manner and ensuring accurate, project-significant, and rapid design change identification, a number of benefits are brought into the collaborative design: for example, a tedious and omission-prone work that a designer searches for those changed portion manually is eliminated; the designer is allowed to focus more on his/her design work without being distracted by identifying and labeling the design changes; and it is allowed to transfer only data of the changed portion of the model (i.e., the changed portion identified by the change identification algorithm) during data transmission between designers, thereby improving the efficiency of data transmission.

### BRIEF DESCRIPTION OF THE DRAWINGS

FIGS. 1(a)-1(c) are schematic diagrams of design changes at three design change levels according to an embodiment of the present disclosure, wherein FIG. 1(a) is change at object level, FIG. 1(b) is change at type level, and FIG. 1(c) is change at model level;

FIG. 2 is a flowchart of a method for automatically identifying design changes in BIM according to an embodiment of the present disclosure;

FIG. 3 is a flowchart of generating object code according to an embodiment of the present disclosure;

FIG. 4 is a flowchart of a method for automatically identifying design changes in BIM according to another embodiment of the present disclosure;

FIG. 5 is a schematic diagram showing element numbers of three raw models among BIM models according to an embodiment of the present disclosure;

FIGS. 6(a) and 6(b) are change identification outcomes of M3_All-DA(M) subjected to a matching priority algorithm and a comparison priority algorithm, respectively, according to an embodiment of the present disclosure, wherein FIG. 6(a) refers to a change identification outcome of the matching priority algorithm, and FIG. 6(b) refers to a change identification outcome of the comparison priority algorithm.

### DETAILED DESCRIPTION OF THE EMBODIMENTS

The present disclosure will be described in detail below with reference to the accompanying drawings. It should be understood, however, that the accompanying drawings are provided only for a better understanding of the present disclosure, instead of limitation to the present disclosure. In the description of the present disclosure, it is should be understood that terms are used for illustrative purposes only, instead of indicating or implying relative importance.

### Embodiment 1

The present embodiment discloses an method for automatically identifying design changes in a building information model (BIM), which comprises the following steps: S1, taking out an object from an old file or a new file; S2, extracting data objects of all data change categories in the object; S3, checking for change at object level, and determining whether a data object of each category could be equal to an object in the new or old file, if so, then the object is not changed, if not, proceeding to the next step; S4, determining whether the two objects that are not equal in the step S3 match each other, if so, the object is the one that has been changed (MODIFY), if not, the object is the one that has been deleted (DELETE) or newly added (NEW); S5, checking whether change at type level occurs; S6, upon completion of checking for the changes at object level and at type level, checking whether the changes are meaningless in the perspective of model level; and S7, outputting an identification outcome and then going back to the step S1 until identification to be applied on all objects in the old or new files has been done. This method ensures accuracy and project significance of a BIM outcome by detecting the changes at type level and at model level without identifying any outcome of meaningless.

As a standard for identifying design changes, as long as design change classifications do have their own project significance, it can be ensured that the outcomes will also possess their project significance while they have been correctly resulted from a change identification algorithm. The existing standard of design change classifications only simply divides changes into three categories: NEW, DELETE, and MODIFY, which are far from describing the change of the model in terms of semantics. For example, a geometric expression of a geometric element is to be changed, e.g., from a solid model to a surface model, without changing its meaning. In terms of semantics, this is not considered as a change. However, since the current standard of change classifications cannot understand the meaning in terms of semantics, this can only be classified as a change. As such, the present embodiment proposes such a design change classification that takes project significance into account and will examine and determine design changes from two aspects: (1) categories of data changes; (2) levels of design changes.

According to the following three data categories that data changes involve, the data changes are divided into:

(1) Attribute Data: represents the attributes of an object, such as parameter information, material properties, user-defined attributes, etc.

(2) Shape Data: represents the shape of an object, such as geometry and position.

(3) Relationship Data: represents the relationship between objects, such as the relationship between a wall and a door.

For the category of Attribute Data, possible classifications of data changes are as follows:

(1) New: newly add an attribute to an object.

(2) Delete: delete an existing property from an object.

(3) Modify Attribute Value: modify a value of an attribute.

(4) Modify Attribute Name: modify the name of an attribute without modifying its value content.

(5) Modify Order of Attributes: modify the order of partial attributes in an object. For the Shape Data, possible classifications of data changes are as follows:

(1) New: newly add a geometric attribute to an object.

(2) Delete: delete a geometric attribute from an object.

(3) Modify Geometry: modify the geometry of an object.

(4) Modify Position: e.g., zoom in/out, translate, and rotate.

(5) Modify Expression: e.g., change the geometric expression from a solid model to a surface model.

For Relationship Data, possible classifications of data changes are as follows:

(1) New: newly add a relationship attribute to an object.

(2) Delete: delete a relationship attribute from an object.

(3) Modify Relational Object: modify data of an object involved in the relationship.

(4) Modify Object's Connection Relationship: modify the relationship between connected objects, e.g., change the connection between object A and object B to object A and object C.

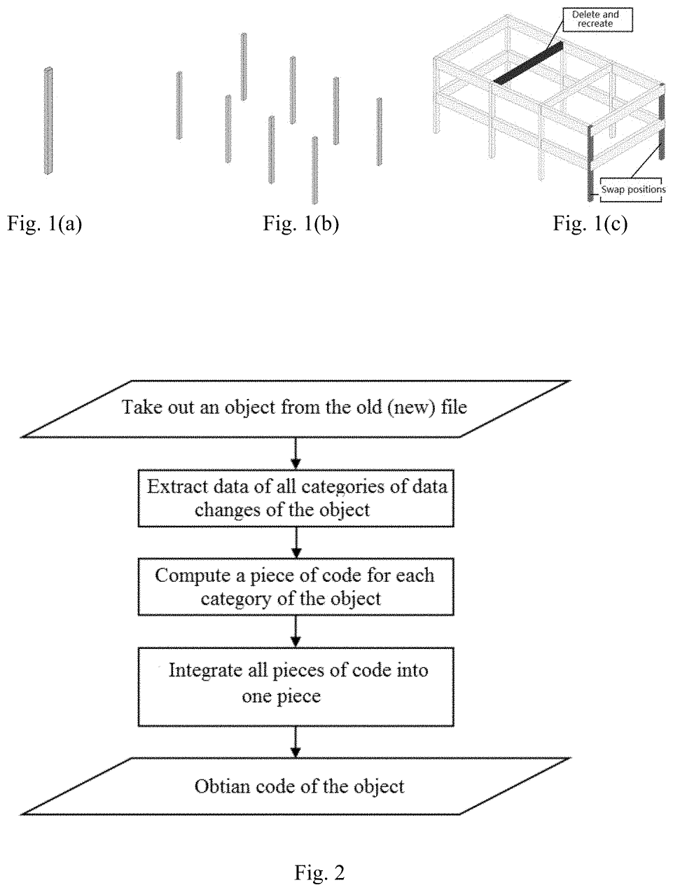

Identifying data changes is only a part of identifying design changes. Design changes should be checked in the perspective of the following three levels, as shown in FIGS. 1(a)-1(c), which are:

Object level: design change identified at this level serves as the data change. This is the most basic level of design change identification, that is, changes that occur are checked one by one by using a single object as a target.

Type level: after the change at object level is checked, it is further to check if change at type level has occurred. For example, if it is identified that the lengths of a plurality of columns have changed equally, then this may be because these columns belong to the same type and this type has been changed.

Model level: after the check for the changes at object level and at type level is completed, further check should be performed in the perspective of model level to see if the changes are meaningless. For example, in the case that the positions of two identical columns are swapped with each other, it is considered as a change of meaningless from the perspective of the model as a whole, and thus should not be identified. Similarly, it is meaningless to delete an object but newly add the same one.

In this embodiment, the change at type level in the step S5 is: to figure out Modify Attribute Value, Modify Attribute Name, and Modify Order of Attributes in modification of the category of Attribute Data; to figure out Modify Geometry, Modify Position, and Modify Expression in modification of the category of Shape Data; to figure out Modify Relational Object and Modify Object's Connection Relationship in modification of the category of Relationship Data; and to classify, from all objects, the objects that have undergone the same data change into the same class.

### Embodiment 2

Although the method for automatic identification according to Embodiment 1 can identify design changes in a manner that is accurate and possesses project significance, it has to cost a relative long time as this method is an improvement enabled based on a comparison priority algorithm. As such, based on the same inventive concept as that of Embodiment 1, the present embodiment provides a method for automatically identifying design changes in BIM in a manner that is not only accurate and project-significant but also less time-consuming. As shown in FIG. 2, the method specifically comprises the following steps S1 to S4.

S1, all objects in both the old and new files are encoded, wherein code resulted may be hash code, object signature, object fingerprint, etc., and then an object is taken out of the old or new file;

S2, it is determined whether the code of the object can be equal to code of one or more objects in the new or old file, if so, then the object is not changed, if not, proceeding to the next step;

S3, it is determined whether the object can match an object in the new or old file, if so, the object is a Modify object, if not, the object is a Delete or New object; and

S4, an identification outcome is output and it is returned to the step S1 until identification to be applied on all objects in the old or new files is completed.

Object information encoding can map object data of arbitrary size to data of fixed size. A major property of the encoding is that the same data will result in identical code, but identical code doesn't mean that their respective raw data are the same (but most likely they are). Code being identical but resulted from different raw data is called encoding conflict (such as hash collision). A good encoding method generally makes the possibility of encoding conflict very low. In a design change identification process, the time cost is proportional to an amount of data to be read, and if it is possible to compute one piece of code for each object, then the code can be used to filter those unequal objects in the step of comparison. Therefore, the properties of two objects are required to be compared only if their respective pieces of code are equal, which greatly reduces the amount of data to be read and thus is less time-consuming. Considering that the probability of encoding conflict in an application is generally zero or very low, it can be directly concluded that two objects whose respective code are equal are the same, which can further reduce the time cost.

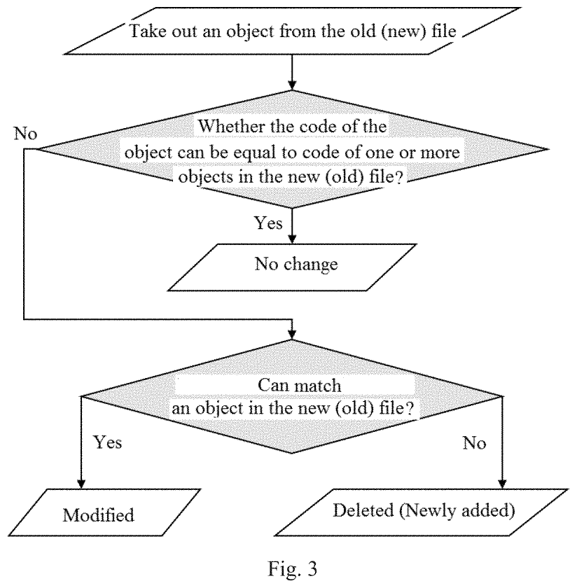

A method for determining the code, as shown in FIG. 3, specifically includes:

S1.1, taking out an object from the old or new file;

S1.2, extracting data of all categories of data changes of the object, wherein the categories of data changes are those in Embodiment 1, which will not be described any further here;

S1.3, computing a piece of code for each category of the object according to the data of all categories of data changes of the object; and

S1.4, integrating all pieces of code into one piece, and using it as object code. In this case, in order for integrating all pieces of code into one piece in the step

S1.4, it is required to check the change at object level, the change at type level and the change at model level in turn, and to check whether the changes are meaningless in the perspective of model level.

### Embodiment 3

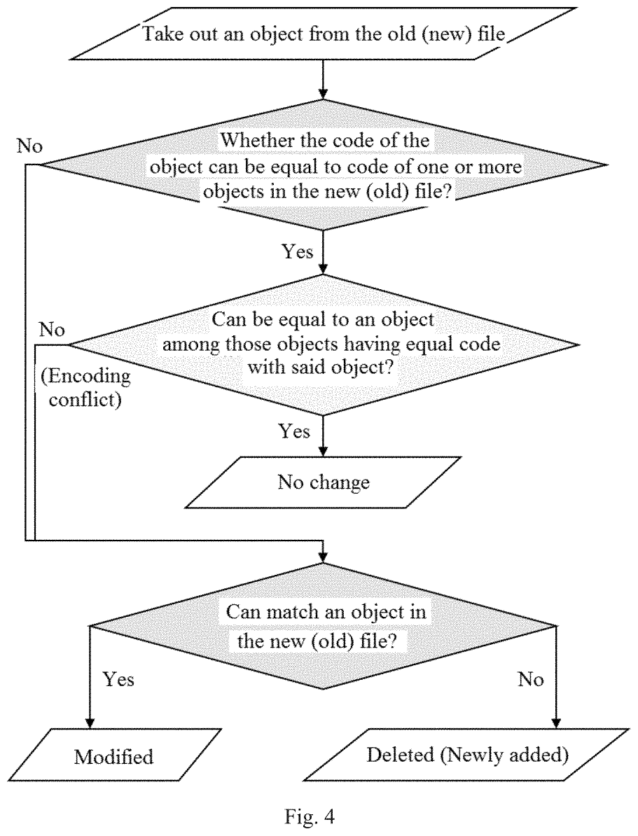

Based on the method for automatic identification of Embodiment 2, the present embodiment adds a step of proofreading to avoid encoding conflicts. In the method for automatic identification of Embodiment 2, it is assumed that encoding conflicts never occur, that is, the code computed for different objects must be different from one another. In fact, an encoding conflict does have a very low probability of occurrence. In order to address the problem of encoding conflicts, the present embodiment adds a step of proofreading on the basis of Embodiment 2. As shown in FIG. 4, the step of proofreading specifically includes: in the step S2 in Embodiment 2, it is determined whether the code of said object can be equal to code of one or more objects in the new or old file, if so, then it is determined whether said object is the same as an object among those objects having the same code with it, if so, then said object is not changed, otherwise, it is determined as an encoding conflict, and proceeding to the step S3 in Embodiment 2. An approach for determining whether the objects are the same is similar to the step of “comparison” as previously mentioned, and is to perform comparison on the basis of all attributes except the code. Although addition of this step might increase a certain amount of time cost, a large number of times of object attribute comparison can still be saved compared with the traditional comparison priority algorithm so that the time cost is reduced.

To balance the time cost and the accuracy, a method as following may be used in practice: running, first, the method for automatic identification in Embodiment 2 to identify design changes, and feeding, after an identification outcome is obtained, the outcome to an user, and then running further the method for automatic identification of the present embodiment to proofread the identification outcome. Note that since the code of the objects have been computed in the first pass of running, the time for computing the code can be saved while the algorithm in the second pass of running is executing, so that a total time of the two passes of algorithm running is basically the same as the time of running alone the method for automatic identification in the present embodiment. In this manner, instead, the user can receive the outcome in advance, thereby reducing a lot of waiting time and improving user experience.

### Embodiment 4

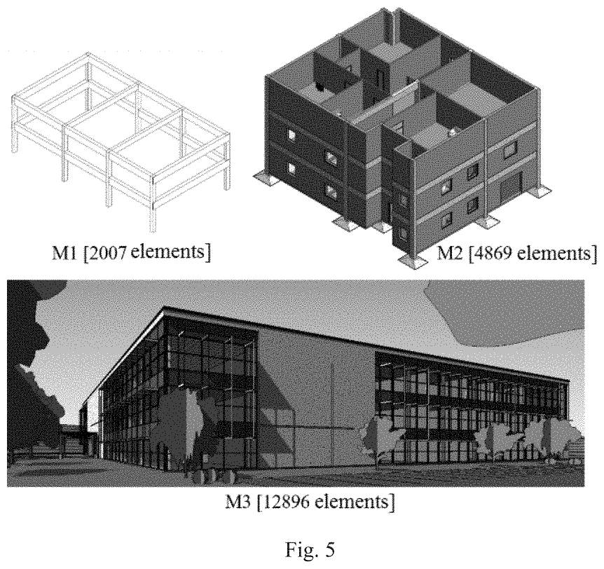

In order to test the performance such as accuracy, project significance and time cost of the methods for automatic identification in both Embodiment 2 and Embodiment 3, three sets of BIM models are established in AutodeskRevit in the present embodiment. As shown in FIG. 5, each set of original BIM models contains 11 models, wherein one of them is a raw model, and each of the other 10 is a derived model which is resulted from change of a certain category that the raw model has produced. The specific categories of changes of the derived model are shown in Table 1.

TABLE 1
Information of design changes of an example BIM model

| | | Design |
|---|---|---|
| | | change |
| Model name^{a} | Data change category | level |
| Mx | — | — |
| Mx_All-A | Newly add Attribute, Shape, Relationship | Object |
| | Data | |
| Mx_All-D | Delete Attribute, Shape, Relationship Data | Object |
| Mx_All-DA(M)^{b} | Newly add Attribute, Shape, Relationship | Model |
| | data after deletion | |
| Mx_A-MG | Modify Geometry in Shape Data | Object |
| Mx_A-MG(T) | Modify Geometry in Shape Data | Type |
| Mx_A-ML | Modify Position in Shape Data | Object |
| Mx_A-ML(M)^{b} | Modify Position in Shape Data | Model |
| Mx_P-MV | Modify Attribute Value in Attribute Data | Object |
| Mx_R-MI(M) | Modify Relational Object in Relationship | Model |
| | Data | |
| Mx_R-MR | Modify Relationship in Relationship Data | Object |

^{a}Mx represents the set of models M1, M2 or M3.
^{b} These two models have only meaningless changes.

The present embodiment adopts the matching priority algorithm, the comparison priority algorithm, the method for automatic identification of Embodiment 2, and the method for automatic identification of Embodiment 3 (the latter two are illustrated by taking hash code as an example), respectively, to identify changes of 10 derived models in each of the three sets of BIM models, and output the change identification outcomes and the time cost through a Form application. Meanwhile, in this embodiment, two different tests are carried out under the conditions of the IDs being reliable and the IDs being unreliable, respectively.

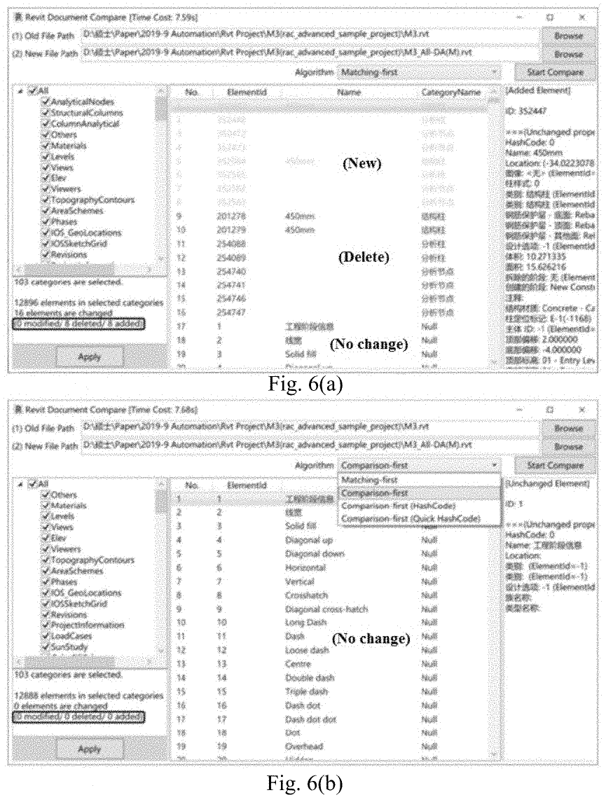

Due to space limitations, FIGS. 6(a) and 6(b) illustrates only change identification outcomes resulted by applying the four algorithms on M3_All-DA(M). Note that FIG. 6(b) shows a screenshot of a change identification outcome of the comparison priority algorithm, and change identification outcomes of another two encoding-based identification algorithms are exactly the same as the former.

As shown in FIGS. 6(a) and 6(b), under the condition of the IDs being reliable, the matching priority algorithm identifies all changes, including those meaningless changes (see FIG. 6(a)), while the change identification outcomes of the other three algorithms are all correct. In fact, for each of the models Mx All-DA(M) (deleting some objects and recreating the same objects) and M3_A-ML(M) (swapping the positions of two equal objects, such as columns or beams), which only have meaningless changes, a correct change identification outcome should be no change at all in the model, which is exactly the change identification outcome of each of the other three algorithms (FIG. 6(b)). In addition, since the method for automatic identification of Embodiment 2, the method for automatic identification of the Embodiment 3, and the comparison priority algorithm have the same change identification outcomes, it can be seen that there is no encoding conflict during code computation of the objects in the models.

Under the condition of the IDs being unreliable, the identification outcome of the matching priority algorithm is completely incorrect, so its time cost is not significant to be as reference, while the change identification outcomes of the other three algorithms are all correct. In this case, however, the time cost of the comparison priority algorithm is very high, even unacceptable. Rather, the time cost of each of the methods for automatic identification of Embodiment 2 and Embodiment 3 is just slightly increased compared with that under the former condition.

Table 2 shows average time cost of the four algorithms in the test which is performed based on a laptop using an Intel i7-9850H CPU (2.60-4.60 GHz).

In the cast that the IDs are reliable, it is shown that the matching priority algorithm takes the least time, while the comparison priority algorithm takes almost the same time as the former. The time cost of the method for automatic identification of Embodiment 2 is about 5%-14% longer than that of the matching priority algorithm, and the difference would gradually decrease as the number of objects increases (from M1 to M3). However, the time cost of the method for automatic identification of Embodiment 3 is about twice that of the comparison priority algorithm, and the difference would increase with the increase of the number of objects.

In the cast that the IDs are unreliable, the matching priority algorithm is inapplicable, while the time cost of the comparison priority algorithm increases significantly. When the number of elements is about 5000 or 13000, the time cost will increase by about 10 or 50 times than before, which is not acceptable in practice. In contrast, the time cost of each of the methods for automatic identification of Embodiment 2 and Embodiment 3 is only 2% -5% longer than the case that the IDs are reliable.

Therefore, it can be concluded that the automatic identification methods of Embodiment 2 and Embodiment 3 each are steady in time cost and have little correlation with the reliability of the IDs, while the time cost of the comparison priority algorithm is sensitive to the reliability of the IDs. When the model is of large scale, the method for automatic identification of Embodiment 2 can save 98.1% of the time compared with the traditional comparison priority algorithm so that the algorithm of Embodiment 2 is completely applicable to a project. At the same time, it should be noted that the invention is applicable to a variety of BIM formats and software tools (such as AutodeskRevit, IFC), and is compatible with different object information encoding methods.

TABLE 2
Average time cost of four algorithms
in the tests for three sets of models

| | | Average Time Cost of Algorithms (s) | | | |
|---|---|---|---|---|---|
| | Model | Matching- | Comparison- | Embodi- | Embodi- |
| Condition | Name | priority | priority | ment 2 | ment 3 |
| IDs being | M1 | 0.49 | 0.50 | 0.97 | 0.57 |
| reliable | M2 | 1.9 | 2.0 | 3.8 | 2.2 |
| | M3 | 7.6 | 7.7 | 15.2 | 8.1 |
| IDs being | M1 | — | 2.8 | 0.99 | 0.59 |
| unreliable | M2 | — | 21.2 | 4.0 | 2.3 |
| | M3 | — | 450.1 | 15.5 | 8.4 |

The foregoing embodiments are only used to illustrate the present disclosure. Structures, connection manners and manufacturing processes of the various components can be changed to some extent. Any equivalent transformation and improvement based on the technical solutions of the present disclosure should not be excluded from the scope of protection of the present disclosure.

1. A method for automatically identifying design changes in a building information model, IBM, comprising steps of:
S1, taking out an object from an old file or a new file;
S2, extracting data objects of all data change categories in the object;
S3, checking for change at object level, and determining whether a data object of each category can be equal to any object in the new or old file, if so, then the object is not changed, if not, proceeding to a next step;
S4, determining whether an ID of the object in the step Si matches an ID of any object in the new file or the old file, if so, the object is the one that has been modified, if not, the object is the one that has been deleted or newly added;
S5, checking whether change at type level occurs;
S6, upon completion of checking for the changes at object level and at type level, checking whether the changes are meaningless at model level; and
S7, outputting an identification outcome and then going back to the step Si until identification to be applied on all objects in the old or new files is completed.

2. The method for automatically identifying design changes in a BIM according to claim 1, wherein, in the step S2, the data change categories of the object includes: a category of attribute data, a category of shape data, and a category of relationship data.

3. The method for automatically identifying design changes in a BIM according to claim 2, wherein, data changes in the category of attribute data include: newly adding, deleting, and modifying attribute data; data changes in the category of shape data include: newly adding, deleting, and modifying geometry; data changes in the category of relationship data include: newly adding, deleting and modifying relational object, and modifying object's connection relationship.

4. The method for automatically identifying design changes in a BIM according to claim 3, wherein, the type level in the step S5 is to: figure out modifying attribute value, modifying attribute name, and modifying order of attributes in modification of the category of attribute data; figure out modifying geometry, modifying position, and modifying expression in modification of the category of shape data; figure out modifying relational object and modifying object's connection relationship in modification of the category of relationship data; and classify, from all objects, the objects that have undergone an identical data change into one same class.

5. A method for automatically identifying design changes in a BIM, comprising steps of:
S1, encoding all objects in an old file and a new file, and taking out an object from the old or new file;
S2, determining whether code of the object can be equal to code of one or more objects in the new or old file, if so, then the object is not changed, if not, proceeding to a next step;
S3, determining whether the object can match an object in the new or old file, if so, the object is a modified object, if not, the object is a deleted or newly added object; and
S4, outputting an identification outcome and returning to the step Si until identification to be applied on all objects in the old or new files is completed.

6. The method for automatically identifying design changes in a BIM according to claim 5, wherein, a method for determining the code specifically comprises steps of:
S1.1, taking out an object from the old or new file;
S1.2, extracting data of all categories of data changes of the object;
S1.3, computing a piece of code for each category of the object according to the data of all categories of data changes of the object; and
S1.4, integrating all pieces of code into one piece, and using it as object code.

7. The method for automatically identifying design changes in a BIM according to claim 6, wherein, in the step S1.2, the categories of data changes of the object include: a category of attribute data, a category of shape data, and a category of relationship data.

8. The method for automatically identifying design changes in a BIM according to claim 7, wherein, data changes in the category of attribute data include: adding, deleting and modifying attribute value, modifying attribute name, and modifying order of attributes; data changes in the category of shape data include: adding, deleting and modifying geometry, modifying position, and modifying expression; and data changes in the category of relationship data include: adding, deleting and modifying relational object, and modifying object's connection relationship.

9. The method for automatically identifying design changes in a BIM according to claim 6, wherein, said integrating all pieces of code into one piece in the step S1.4 requires to check for change at object level, change at type level and change at model level in turn, and to check whether the changes are meaningless at the model level.

10. The method for automatically identifying design changes in a BIM according to claim 5, wherein, the method further comprises a step of proofreading to avoid an encoding conflict; the step of proofreading specifically comprises: in the step S2, determining whether the code of said object can be equal to code of one or more objects in the new or old file, if so, then determining whether said object is completely identical with an object among those objects having equal code with said object, if so, then said object is not changed, otherwise, it is determined that there is an encoding conflict, and proceeded to the step S3.
